(19) United States
(12) Patent Application Publication
(10) Pub. No.: US 2013/0030887 A1
(43) Pub. Date: Jan. 31, 2013

(54) CUSTOMER REWARD AND LOYALTY SYSTEM

(71) Applicants: Matthew A. Calman, Charlotte, NC (US); Margery Kiehn, Greensboro, NC (US); Jamie Armistead, San Francisco, CA (US); Erik Stephen Ross, Charlotte, NC (US); Sanchit Gupta, Jersey City, NJ (US); Shoshana Tzipporah Asher Holtzblatt, New York, NY (US); Honray Lin, San Mateo, CA (US); Molly Nix, Concord, MA (US); Sriram Ramasubramanian, Sunnyvale, CA (US)

(72) Inventors: Matthew A. Calman, Charlotte, NC (US); Margery Kiehn, Greensboro, NC (US); Jamie Armistead, San Francisco, CA (US); Erik Stephen Ross, Charlotte, NC (US); Sanchit Gupta, Jersey City, NJ (US); Shoshana Tzipporah Asher Holtzblatt, New York, NY (US); Honray Lin, San Mateo, CA (US); Molly Nix, Concord, MA (US); Sriram Ramasubramanian, Sunnyvale, CA (US)

(73) Assignee: BANK OF AMERICA CORPORATION, Charlotte, NC (US)

(21) Appl. No.: 13/357,344

(22) Filed: Jan. 24, 2012

Related U.S. Application Data
(60) Provisional application No. 61/513,262, filed on Jul. 29, 2011.

(51) Int. Cl. G06Q 30/02

(52) U.S. Cl. 705/14.14; 705/14.32; 705/14.4

(57) ABSTRACT

Embodiments of the invention relate to systems, methods, and computer program products for implementing a customer loyalty rewards program by assigning point values to a customer's completion of certain activities, monitoring the customer's activities to determine when the customer has completed an activity, crediting the customer the assigned value of points for the completed activities, correlating points to one or more rewards and facilitating the exchange of rewards.

### CROSS-REFERENCE TO RELATED APPLICATIONS

This application claims priority to U.S. Provisional Patent Application Ser. No. 61/513,262, filed Jul. 29, 2011, entitled “Customer Loyalty Rewards Program,” the entirety of which is incorporated herein by reference.

### FIELD

In general, embodiments of the invention relates to methods, systems, apparatus and computer program products for implementing a customer loyalty rewards program.

### BACKGROUND

Many merchants, e.g. retailers, financial institutions etc., provide their customers with a customer loyalty rewards program. Typically, customers that participate in these programs receive some defined benefit in exchange for continuing to be an active customer of the merchant. Because customer loyalty rewards programs are becoming increasingly popular with customers, there is a need to improve the ways in which merchants implement and provide such programs.

### SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Some embodiments provide a method for implementing a customer loyalty rewards program that includes assigning point values to a customer's completion of one or more activities, monitoring the customer's activities to determine when the customer has completed an activity, crediting the customer the assigned value of points for completed activities, correlating points to one or more rewards and facilitating the exchange of rewards. In some embodiments the rewards comprise discounts for goods or services, the amount and nature of which is concealed from the customer until the customer receives the reward and elects to learn the details of the discount. In some embodiments the rewards comprise discounts for goods or services in a specific general category with the amount and nature of the discounts concealed from the customer until the customer receives the reward and elects to learn the details of the discount. In further embodiments, the rewards are only valid for a limited period of time.

In certain embodiments the one or more activities that are assigned point values are selected from: participating in a specified program, maintaining a specified balance in an account, meeting specific goals, contributing to a charity, completing a transaction with a specified financial instrument, remaining a customer of the merchant for a specified period of time, or referring other customers to become customers of the merchant.

In some embodiments, facilitating the exchange of rewards comprises transferring one or more rewards to the customer in exchange for a corresponding number of points credited to the customer. In some embodiments, facilitating the exchange of rewards comprises creating a marketplace, wherein the rewards may be purchased, sold, traded or gifted by and between customers of the merchant.

Some embodiments of the invention further comprise identifying a plurality of customer groupings, wherein each grouping corresponds to a value to the merchant and determining to which customer grouping the customer belongs. In such embodiments, correlating points to one or more rewards is based in part on the customer grouping to which the customer belongs.

Certain embodiments involve creating a social network environment, wherein customers can elect to associate with one or more other customers of the merchant. In such embodiments, the method will include the additional step of communicating activities by which a customer may earn points, via the customer's connections in the social network. Such embodiments may further include facilitating the exchange of rewards by enabling the exchange of rewards between customers connected through the social network.

In some embodiments, the one or more rewards comprise an opportunity to participate in a game of chance to receive additional rewards. In such embodiments, facilitating the exchange of rewards comprises presenting a game of chance wherein participants receive one of a number of rewards of varying value according to predetermined rules. In some embodiments the game of chance is a rewards wheel. The rewards wheel may be an electronic representation of a rewards wheel.

In other embodiments, facilitating the exchange of rewards involves identifying the customer's current location by locating the customer's mobile device, correlating the customer's location to available rewards within a predetermined distance from the customer's location and notifying the customer of the available rewards proximate to the customer's location.

Embodiments of the invention also include an apparatus comprising a memory that include assigned point values associated with a customer's completion of one or more activities, a processor operably connected to the memory and configured to assign monitor the customer's activities to determine when the customer has completed an activity, credit the customer the assigned value of points for the completed activities, correlate points to one or more rewards, facilitate the exchange of the one or more rewards and provide information for presentation to the customer about the credited points and the one or more rewards.

In some embodiments of the apparatus, the one or more activities are selected from participating in a program, maintaining a specified balance in an account, meeting specific goals, contributing money to a charity, completing a transaction with a specified financial instrument, remaining a customer for a specified period of time or referring other customers.

The one or more rewards may comprise discounts for goods or services, the amount and nature of which is concealed from the customer until the customer elected to learn the details of the discount. The one or more rewards may also be discounts for goods or services in a specific category the amount and nature of which is concealed from the customer until the customer elects to learn the details of the discount. These rewards may only be valid for a limited period of time.

In certain embodiments, the processor, in facilitating the exchange of rewards, is configured to transfer one or more rewards to the customer in exchange for credited points. In other embodiments, the processor in facilitating the exchange of rewards is configured to create a marketplace, wherein the rewards may be purchased, sold, traded or gifted by and between customers.

The processor of the apparatus may also be configured to identify a plurality of customer groupings, wherein each grouping corresponds to a value to the merchant and to determine to which customer grouping the customer belongs. In such embodiments, correlating points to one or more rewards is based in part on the customer grouping to which the customer belongs.

In other embodiments, the processor is further configured to create a social network environment, wherein customers can elect to associate with one or more other customers of the merchant. In such embodiments, the processor may also be configured to communicate additional activities through which a customer may earn points through the customer's connections in the social network. Further, the processor may be configured to facilitate the exchange of rewards by enabling the exchange of rewards between customers connected through the social network.

In some embodiments of the apparatus, the one or more rewards may include an opportunity to participate in a game of chance to receive additional rewards. In such embodiments, the processor in facilitating the exchange or rewards is configured to present a game of chance via the display, wherein participants receive one of a number of rewards of varying values according to predetermined rules. The game of chance in some embodiments is a rewards wheel and in some embodiments is an electronic rewards wheel.

Certain embodiments of the apparatus involve the processor being configured to identify the customer's location via a mobile device, correlate the customer's location to available rewards within a predetermined distance form the customer's location and notify the customer of the available rewards proximate to the customer's location.

Embodiments of the present invention also include a computer program product comprising a non-transitory computer readable medium having computer-executable code stored thereon. The computer-executable code may include a first code portion configured to monitor a customer's activities, a second code portion configured to award a predetermined number of points to the customer for the completion of designated activities and a third code portion configured to exchange the customer's points for one or more rewards.

In some embodiments, the third code portion, in exchanging the customer's points for one or more rewards is configured to transfer one or more rewards to the customer in exchange for credited points. In other embodiments, the third code portion is configured to create a marketplace, wherein rewards may be purchased, sold, traded or gifted by and between customers.

The computer-program product, in some embodiments, may also include a code portion configured to identify a plurality of customer groupings, wherein each grouping corresponds to a value to the merchant and to determine to which customer grouping the customer belongs. In some such embodiments, the predetermined point value awarded to a customer for the completion of designated activities is based in part on the customer grouping to which the customer belongs.

In certain embodiments, the computer-program product also includes a code portion configured to create a social network environment, wherein customers can elect to associate with one or more other customers of the merchant. In such embodiments, the computer-program product may also include a code portion configured to communicate additional activities through which a customer may earn points through the customer's connections in the social network. In further embodiments, the third code portion in exchanging the customer's points for one or more rewards is configured to enable the exchange of rewards between customers connected through the social network.

In embodiments of the computer-program product the one or more rewards may include an opportunity to participate in a game of chance, such as a rewards wheel, in order to receive additional rewards. In such embodiments, the computer-program product further comprises a fourth code portion configured to present the game of chance, wherein participants receive one of a number of rewards of varying values according to predetermined rules.

The third code portion of the computer program product, in some embodiments is configured to identify the customer's location via a mobile device, correlate the customer's location to available rewards within a predetermined distance from the customer's location and notify the customer of the available rewards proximate to the customer's location.

Embodiments of the present invention also include a method for attracting customers to a financial institution platform. This method involves providing electronic games on a financial institution platform and enabling customers to access the electronic games. In some such embodiments, the electronic games provide customers with rewards for participating in the game.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a flow diagram illustrating a process flow for an apparatus for implementing a customer loyalty rewards program, in accordance with embodiments of the invention.

FIG. 2 is a flow diagram illustrating a process flow for an apparatus for assigning customers to customer groupings and providing rewards based in part on the customer grouping, in accordance with embodiments of the invention.

FIG. 3 is a flow diagram illustrating a process flow for implementing a customer loyalty rewards program by creating a social network, in accordance with embodiments of the invention.

FIG. 4 is a mixed block diagram and process flow illustrating facilitating the exchange of rewards, in accordance with embodiments of the invention.

FIG. 5 is a block diagram illustrating technical components of a system for implementing a customer loyalty rewards program, in accordance with an embodiment of the present invention.

FIG. 6 illustrates an exemplary display page of a customer interface for implementing a customer loyalty rewards program, in accordance with embodiments of the invention

FIG. 7 illustrates an exemplary display page of a customer interface for implementing a customer loyalty rewards program, in accordance with embodiments of the invention.

FIG. 8 illustrates an exemplary display page of a customer interface for implementing a customer loyalty rewards program, in accordance with embodiments of the invention.

FIG. 9 illustrates an exemplary display page of a customer interface for implementing a customer loyalty rewards program, in accordance with embodiments of the invention.

FIG. 10 illustrates an exemplary display page of a customer interface for implementing a customer loyalty rewards program, in accordance with embodiments of the invention

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

Although embodiments of the present invention described herein are generally described as involving a merchant, it will be understood that merchant may involve one or more persons, organizations, businesses, institutions and/or other entities such as financial institutions, services providers etc. that implement one or more portions of one or more of the embodiments described and/or contemplated herein.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Thus, apparatus, systems, methods and computer program products are herein disclosed for implementing a customer loyalty rewards program. Inasmuch as financial institutions often offer customers a customer loyalty rewards program, specific embodiments disclosed herein relate to financial institutions. However, such embodiments are exemplary.

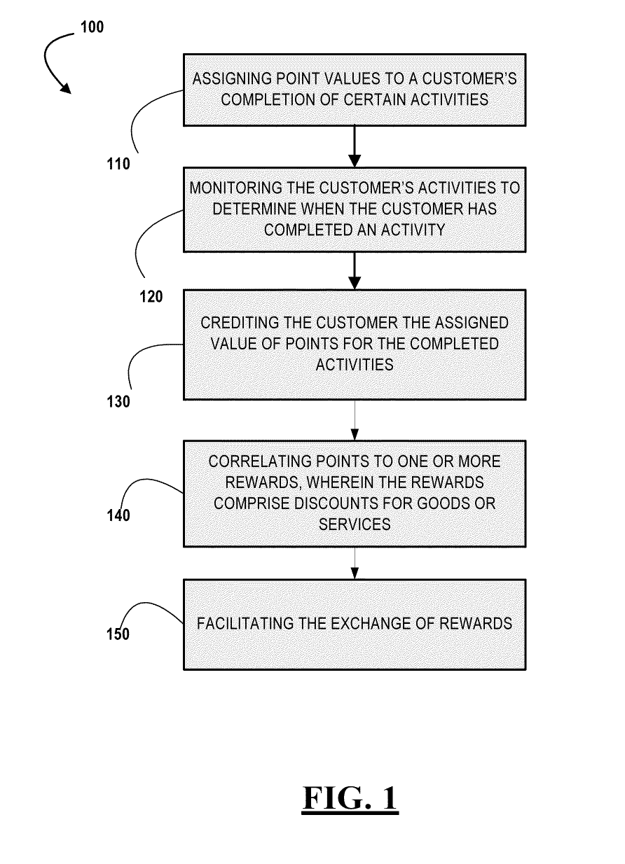

FIG. 1 illustrates a general process flow 100 for an apparatus or system for implementing a customer loyalty rewards program consistent with an embodiment of the present invention. As shown in block 110 point values are assigned to a customer's completion of one or more activities. Such activities may include, but are not limited to becoming a new customer of the merchant, participating in a new program or service provided by the merchant (e.g. enrolling in a bill pay program provided by a financial institution, opening a new account, utilizing an online bill paying service, receiving electronic monthly statements, accessing the financial institution website or a specified portion of a website etc.), maintaining a specified balance in an account (e.g. maintaining $500 or more in a savings account), meeting specific goals (e.g. depositing $50 a month into a savings account for six months, spending $10 or more every week at a grocery store etc.), donating money to a charity, completing transactions with a specified financial instrument (e.g. a designated credit card or debit card), referring other customers to become customer of the merchant, and the like. It will be understood that the specific point values assigned to the completion of each activity is not important and will be dependent on the number of points required to exchange points for rewards as disclosed and contemplated herein. For instance, the completion of an activity may be assigned a point value of one point or one hundred points.

As shown in block 120 the customer's activities are monitored to determine when the customer has completed an activity. Monitoring the customer's activities may be done in any manner sufficient to determine that the customer has completed an activity. However, in some embodiments monitoring the customer's activities will involve monitoring the transactional data and/or customer account history data available to the merchant. Transactional data includes, but is not limited to, data regarding the date, location, amount, method of payment etc. of the transactions of the customer. Account history data includes, without limitation, such data as the types of accounts the customer has with the merchant (e.g. credit, checking, savings, investment, lay-away, financing etc.) and the current and historical balances of such accounts, account activity etc. Accordingly, by way of example, if a merchant has assigned a point value to completing a transaction with its debit card, the merchant may be able to refer to the available transactional data to identify the method of payment used in the customer's transactions and determine when the customer has used the merchant's debit card. Similarly, if the merchant, e.g. a financial institution, has assigned a point value to enrolling in a new savings account, the account history data will allow the financial institution to determine when the activity has been completed.

A customer's activities may also be monitored by monitoring the social network data and Internet data about the customer available to the merchant. It will be understood that “social network” as used herein, generally refers to any social structure made up of individuals (or organizations) which are connected by one or more specific types of interdependency, such as kinship, friendship, common interest, financial exchange, working relationship, dislike, relationships, beliefs, knowledge, prestige, geographic proximity etc. The social network may be a web-based social structure or a non-web-based social structure. In some embodiments, the social network may be inferred from financial transaction behavior, mobile device behaviors, etc. The social network may be a network unique to the invention or may incorporate already-existing social networks as well as any one or more existing web logs or “blogs,” forums and other social spaces. Social network data may provide information regarding the customer's recent, present or future activities through expressed data. For instance, a user may upload a blog post, comment on a connection's page, send a friend an electronic message etc. that indicates that the user likes the merchant or encourages the user's connections to use the merchant's services. Similarly, a user might post a statement indicating that she purchased a luxury item, such as jewelry or new shoes suggesting that the customer has exceeded a budget limitation or failed to meet a savings goal. Monitoring a customer's activities may also be done by monitoring Internet data associated with the customer. Internet data, may include any information relating to the searches conducted by the customer, website's visited by the customer and the like that suggests the customer's activities. For instance, a customer may access a financial institution's website to enroll in a “Bill Pay” service or to elect to receive financial statements in an electronic form.

At block 130, once it has been determined that a customer has completed an activity, the customer is credited the value of points assigned to the activity. To use the examples above, if the merchant assigned ten points for each transaction involving the merchant's debit card, the customer will be credited fifty points if she has used the debit card in connection with five transactions. Similarly, if the financial institution has assigned five hundred points to opening a new savings account, once the account has been opened, the customer will be credited with five hundred points. Further, if the financial institution has assigned one hundred points for electing to receive electronic statements, once the customer has authorized these statements on the financial institution's website, the customer will be credited with the one hundred points. The noted point values are merely exemplary and may vary as discussed and contemplated herein.

As shown in block 140, the points are correlated to one or more rewards. Such rewards can be any incentive or inducement to encourage the customer to complete an activity and include, but are not limited to discounts for goods or services provided by the merchant discounts for goods or services provided by other merchants, offers for services otherwise unavailable to the customer (e.g. VIP services, preferred customer services etc.), reductions in services fees (e.g. reductions to overdraft fees, balance transfer fees, ATM fee etc.) and the like.

In some embodiments, the rewards comprise discounts for goods or services within general categories, such as electronics, travel, office and school supplies, health and beauty, apparel etc. but the amount and nature (e.g. whether the offer is limited to a specific retailer or only for specific products) is concealed from the customer until the customer receives the reward and elects to reveal the details of the discount. For example, the reward may take the form of a gift box. This gift box may be a physical box but may also be a digital or virtual gift box. The gift box may, for example, be identified as an “Electronics Pass” indicating that the box contains an offer related to electronics goods. For instance, an Electronics Pass or Electronics Gift Box may be 10% off any purchase at a particular electronics retailer. Further the gift box may be a “Health & Beauty Pass” indicating that the box contains an offer related to health and beauty products, such as a 2% off any purchase offer at a particular retailer. When the gift box is initially presented to the customer the details of the offer may not be disclosed. In this respect, the specifics of the offer are a surprise. The customer only has the opportunity to reveal the nature of the offer, that is to “open” the gift box, after the customer has selected and received the reward. In some embodiments, the rewards will be valid for a limited period of time (e.g. the discount must be redeemed within thirty days etc.). After the points have been correlated to one or more rewards, the apparatus or system facilitates the exchange of rewards as represented by block 150.

In some embodiments the reward may be an opportunity to participate in a game of chance, such as spinning a rewards wheel, wherein each spin of the rewards wheel provides the customer with an opportunity to win a further reward. The rewards wheel may be an actual physical wheel or may be an electronic representation of a wheel, for instance presented at the merchant's website or as part of the website associated with the social network discussed and contemplated herein. The wheel may be divided up into sections along the circumference of the wheel, wherein each section corresponds to a different potential reward. The available rewards may vary in value from very high, such as a “Jackpot” reward to less valuable rewards. There will be no section of the wheel that does not correspond to a reward. At a minimum, the customer will land on a section giving the customer the opportunity to spin again. As an exemplary embodiment, a financial institution may allow its customers to spin a rewards wheel in exchange for one hundred earned points. In some instances, the customer receives a free spin upon enrolling in the customer rewards program. The merchant may also routinely award free spins either in exchange for completed activities, as a promotional device or after the customer has earned a specific number of points, e.g. after three hundred points the customer receives a free spin. In some embodiments, customers may be able to spin the rewards wheel an unlimited number of times and will receive points each time the customer accesses the financial institution or merchant's site to interact with the rewards wheel. An example of the rewards wheel may include a wheel divided into sections corresponding to the following rewards: Jackpot, spin again, increased checking account interest, a $10 gift card, a free donation to a charity, fee forgiveness, free privacy assist, merchant cash back, five hundred free points, etc. When the customer elects to spin the rewards wheel, the predetermined point value is deducted from the customer's point total or the total number of free spins allotted to the customer is reduced by one. The customer may elect to spin the wheel by actuating a spin button presented on the financial institution website. The system “spins” the reward wheel by providing a graphical representation of the wheel rotating in a circle while running an algorithm to determine the customer's further reward. It will be understood that chances of receiving any one reward may vary according to the value of the reward. Accordingly, the likelihood of the rewards wheel landing on a Jackpot section may be less than the wheel landing on the spin again section. Alternatively, the likelihood that the rewards wheel will land on the section corresponding to a given reward may be random.

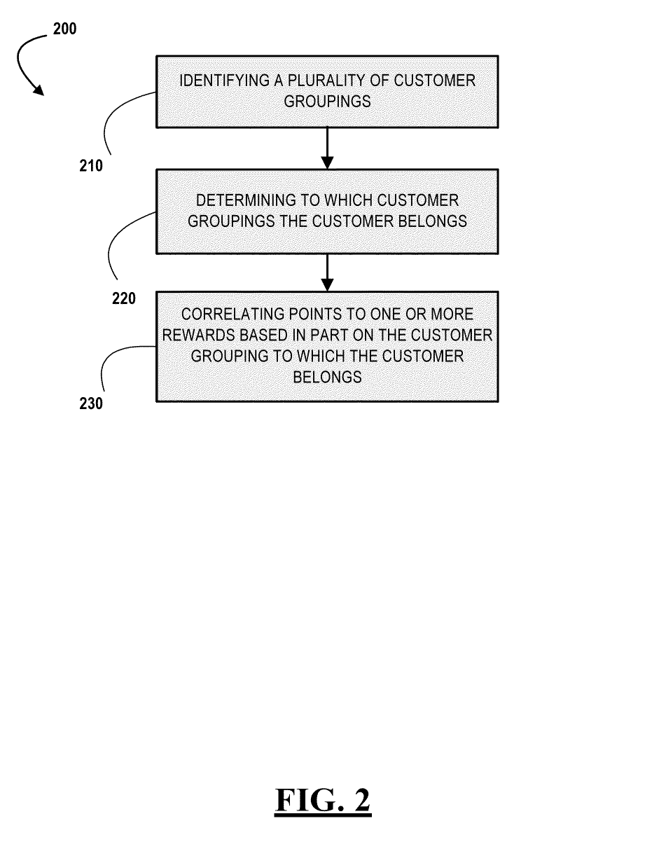

FIG. 2 provides a general process flow 200, for assigning customers to customer groupings and providing rewards based in part on the customer grouping, in accordance with embodiments of the invention. As shown in block 210, a plurality of customer groupings is identified. Customer groupings, in some embodiments will be expressed as levels, e.g gold level, silver level, bronze level. In other embodiments, the customer groupings may be expressed as qualitative rankings, e.g. basic, preferred, sustainer etc. The customer groupings may be made according to any basis by which customers can be differentiated. In some embodiments, the customer groupings may be according to the customer's current or potential value to the merchant. The merchant may determine the customer's current or potential value to the merchant according to available customer data, such as the customer's transaction data, the customer's account history data, social network data and the Internet data about the customer available to the merchant. For instance, if a customer has had a long history with a financial institution, maintains significant assets with the financial institution and the customer's social network data suggests the customer recently received a promotion at work, these factors may result in the customer being assigned to a higher customer grouping than a new customer or a customer who maintains smaller accounts with the financial institution.

As shown at block 220, it is determined to which customer grouping a customer belongs, and at block 230, correlating points to one or more rewards is based in part on the customer grouping to which the customer belongs. Accordingly, in certain embodiments, customers in different customer groupings will have access to different rewards. Consider for example the illustration discussed above where the customers groupings are expressed as gold, silver and bronze levels. A customer who is determined to belong to the gold level will have access to different rewards than a customer determined to belong to the bronze level. In such embodiments, the rewards available to a gold level member will be more valuable than the rewards available to a bronze level member. In certain embodiments, rewards will be labeled as corresponding to different customer groupings. Using the examples provided in reference to FIG. 1, there may be a Gold Electronics Pass, a Silver Office and School Gift Box or a Bronze Health and Beauty Pass etc.

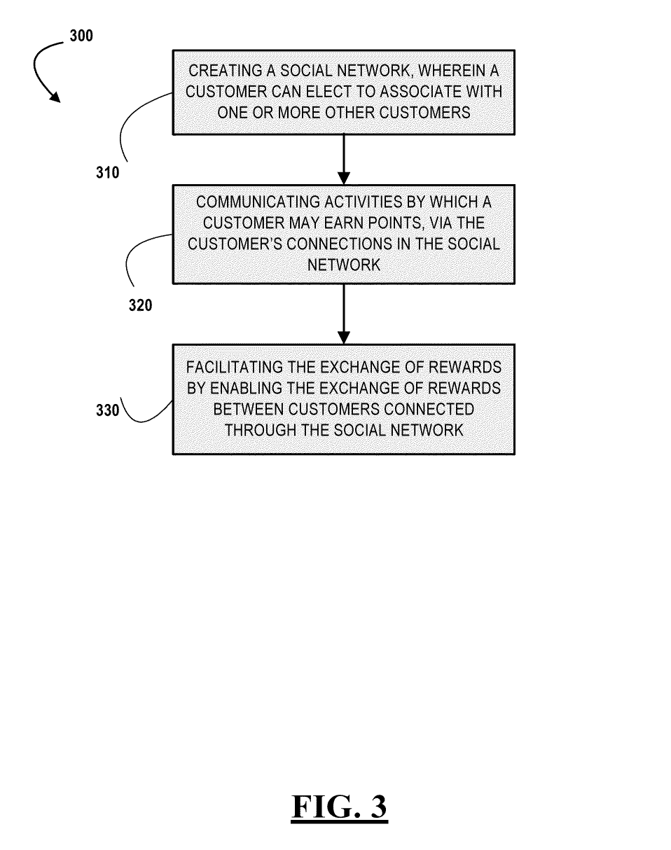

FIG. 3 is a process flow 300 illustrating a process flow for implementing a customer loyalty rewards program by creating a social network, in accordance with embodiments of the invention. As shown in block 310 a social network is created, wherein a customer can elect to associate with one or more other customers. It will be understood that “connection” or “connections” as used herein in the context of a social network refers to one or more members of a customer's social network. In certain embodiments, connections within the social network will be able to communicate with each other, for instance through electronic message, chat, updates, postings and the like. Moreover, connections will be able to receive and view information regarding their connections' activities relating to the customer loyalty rewards program. For instance, connections may receive updates regarding a connection's activities, accumulation of points, receipt of rewards, customer grouping etc. In some embodiments, a user may receive information regarding other customer's activities relating to the customer loyalty rewards program wherein the identity of the other customer is concealed. For instance, a customer may receive an update indicating that another customer has completed a savings goal and received a specified reward. In such an embodiment, the identity of the other customer may be concealed to preserve the privacy of each customer. Alternatively, customers may elect to reveal such information to their connections within the social network. Furthermore, in specific embodiments, as illustrated in 320, activities by which a customer may earn points are communicated via the customer's connections in the social network. For example, if Customer A is a customer of a financial institution and Customer A's brother Customer B, and co-worker Customer C are also customers of the financial institution, Customer A may choose to associate with Customer B and Customer C by becoming connections over the social network created by the financial institution. After becoming connections, Customer A may receive an invitation from Customer B and/or Customer C to participate in activities to earn points. For instance, Customer B may participate in a savings challenge (e.g. depositing 5% of a paycheck per month in a savings account) and invite Customer A to also participate. Similarly, Customer C may indicate that she signed up for a new money market account and earned one thousand points and invite Customer A to do the same. In some embodiments these communications, e.g. invitations, to participate in activities may be purely voluntarily or automated by the social network, but in other embodiments, the connections may receive points or other incentives for inviting and/or getting others to participate in a specified activity. In some embodiments, certain rewards may only be available if a predetermined number of customers participate in an activity. For instance, a ten percent discount to a specified merchant may be available if five or more customers spend $25 or more at the merchant. Similarly, a merchant or financial institution may offer to match a charitable donation for every ten customers who donate to the charity. In such embodiments, the social network may be used to communicate the availability of these offers between connections and to facilitate participation in the group offers.

As shown in block 330, the exchange of rewards is facilitated by enabling the exchange of rewards between connections within the social network. Examples of such exchanges include buying and selling rewards in return for points, trading rewards and gifting rewards. Continuing with the example from above, if Customer A is connected to Customer B and Customer C, Customer A may be able to exchange some, or all of his credited points for a reward received by Customer B or vice versa. Similarly, Customer A may have a reward that Customer C wants and Customer C has a reward that Customer A wants and so they may agree to trade their rewards. Such exchanges may include rewards wherein the nature and amount of the specific discount has been disclosed (e.g. the gift box has been opened). However, in other instances the nature and amount of the specific discounts is still concealed at the time of the exchange. Customers may also be able to pool their earned points with other customers and use their combined point totals to receive a reward. In some embodiments, customers will only be able to combine their point totals with other connections within the social network. In other embodiments, customers will be able to combine point totals with any other customer of the financial institution or merchant. For instance, a family may elect to combine the point totals earned by each family member. Similarly, customers who all work at the same company may elect to pool points and use the points to contribute to a specified charity.

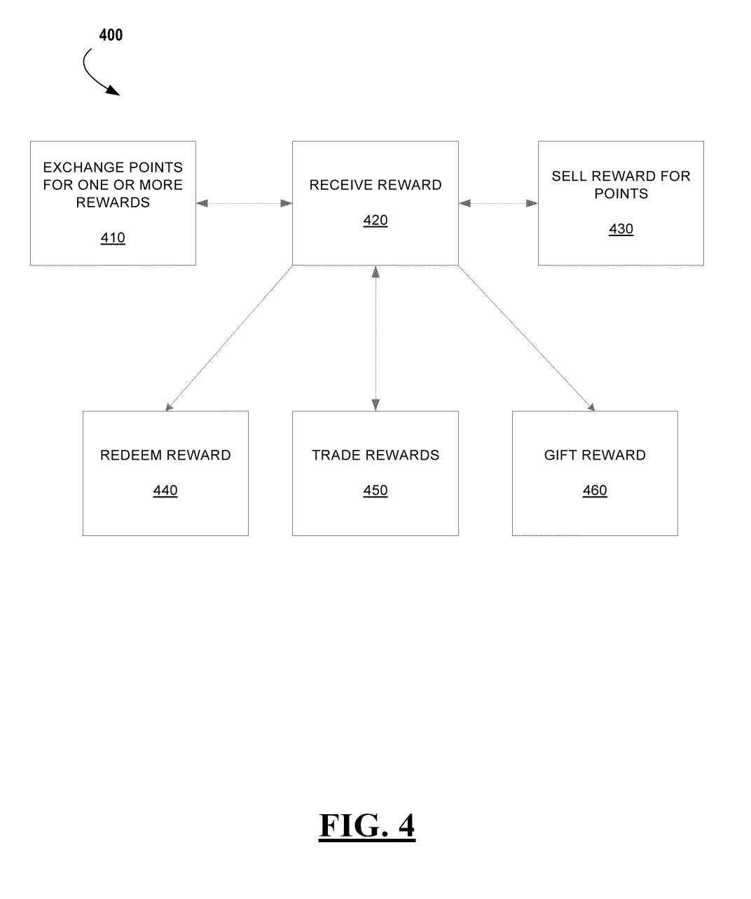

Referring now to FIG. 4, wherein a mixed block diagram and process flow 400 is provided illustrating facilitating the exchange of rewards, in accordance with embodiments of the invention. As shown in block 410, facilitating the exchange of rewards may include the exchange of points for one or more rewards. In such embodiments, the merchant will provide rewards to the customer in exchange for the points credited to the customer (block 130, FIG. 1). By way of example, the merchant may create a secure website, mobile application, software program or the like, that allows the customer to view the balance of points credited to the customer as well as view available rewards and the amount of points required to receive the rewards. Such a secure website, application, or software program may also include functionality to allow the customer to select one or more rewards, view available information about the reward and “purchase” the reward by exchanging points for the reward. In other embodiments, the customer does not transfer credited points to the merchant in exchange for a reward, rather a reward is given to the customer automatically upon reaching a designated points threshold. At block 420, the customer receives the reward. It will be understood that the delivery and receipt of the reward will depend on the nature of the reward. In certain embodiments, the reward may be completely electronic and the delivery of the reward is conducted through the secure website, mobile application or software program. In embodiments where the reward is a physical item, delivering the reward may involve physically shipping or transporting the reward to the customer.

In some embodiments, facilitating the exchange of rewards may also include creating a marketplace, wherein rewards may be purchased, sold, traded or gifted by and between customers. As illustrated at block 430, rewards may be sold to another customer in exchange for credited points. For example, if Customer A has been credited with 1500 points, and Customer B has a reward (e.g. a Gold Apparel Box) that she is interested in selling that has been valued by the merchant at five hundred points, Customer B may transfer the reward to Customer A in exchange for five hundred credited points. Accordingly, the merchant may subtract five hundred points from Customer A's point balance and deliver the reward to Customer A and add five hundred points to Customer B's point balance. In certain embodiments, the price of a reward will not be set by the merchant but will be dependent upon an agreement between the customers.

As shown in block 440, in some instances the customer will elect to redeem the reward, e.g. to utilize the discount. For rewards that involve a business or retailer, other than the merchant that implemented the customer loyalty rewards program, redeeming the reward may involve printing off a coupon, presenting a bar code on a mobile device, visiting the website of the other merchant and entering an assigned code, etc. In some embodiments, the merchant may offer a secure website, mobile application or computer program product that allows a customer to redeem rewards directly with the appropriate merchant. Similarly, for rewards that involve discounts for goods or services provided by the merchant, a website, application or program may also be used by the merchant to redeem rewards. In such embodiments, the customer may log-in to the website, application or program and actuate a button to redeem the reward. For instance, if Customer A receives a reward consisting of reduced monthly charges for thirty-days, Customer A may be able to log-in to a secure website run by the merchant, select rewards and actuate a redeem button to have the monthly charges identified in Customer A's transactional data reduced by the designated amount. In certain embodiments, the customer will have a mobile application associated with the customer rewards loyalty system installed in the memory of a mobile device. In some such embodiments, the mobile application may include a function of indicating that an opportunity to redeem accumulated points for a reward is proximate to the customer's current location. This indication may involve an audible alert, vibration, visual indicator on the display of the mobile device, or the like. In other embodiments, the customer launches the mobile application and requests the device to determine if any rewards are nearby. The mobile device may use a GPS device, accelerometer and the like to determine the customer's current location and determine if any rewards that are available to the customer are located within a predetermined distance from that location. For instance, a customer may be conducting a weekly shopping trip to a grocery store. As the customer enters the store, she opens the mobile application associated with the present invention on her mobile phone and browses available rewards near her current location. The application indicates that there is a $10 cash back reward at a merchant two miles from her present location, which she can redeem in exchange for two hundred rewards point. The mobile application also includes a function of displaying her current rewards point balance and the customer determines that she has enough points to receive the cash back reward. The customer exchanges the points for the reward and travels to the merchant to receive the reward.

As shown in block 450, customers may also be able to trade rewards with other customers. For instance, if Customer A has two Bronze Apparel Gift Boxes and only needs one, he may reach an agreement with Customer B to trade one Bronze Apparel Gift Box for one Bronze Health & Beauty Gift box which Customer B has received. As shown in block 460, a customer may also elect to gift a reward to another customer. Accordingly, if Customer A has two Bronze Apparel Gift Boxes, she may choose to gift one (or both) of the rewards to another customer, e.g. a friend or family member. Trading rewards and/or gifting rewards may be completed by means similar to those described and anticipated above in connection with the exchange or sale of rewards for points. As an example of the above discussed marketplace in use, a merchant, such as a financial institution, may create an online website that allows a customer to log into their account and view accumulated point totals. If the customer has already received one or more rewards (e.g. the customer receives five rewards for initially enrolling in the customer loyalty program etc), the website may also display available rewards. The customer may select one such reward and be presented with a series of buttons inviting the customer to sell, redeem, trade or gift the reward. Actuating any of the buttons will allow the customer to exchange the reward as discussed above. Moreover, the website may include the ability for the customer to browse available rewards by general subject matter (e.g. books and magazines, movies, music, games, electronics, computers, etc.) and be presented with a plurality of offers available under each category. Moreover, the website may display potential rewards recommended for the customer. The recommendation may be based on previous rewards activities, the customer's transactional data, or suggestions from other customers. Similarly, the website may display featured rewards. The customer will be able to view available rewards, and in some instances, view available information about the reward. Selecting a reward will also give the customer an opportunity to “buy” the reward. Actuating the buy button will initiate the transfer of points from the amount credited to the customer and the transfer of the reward to the customer.

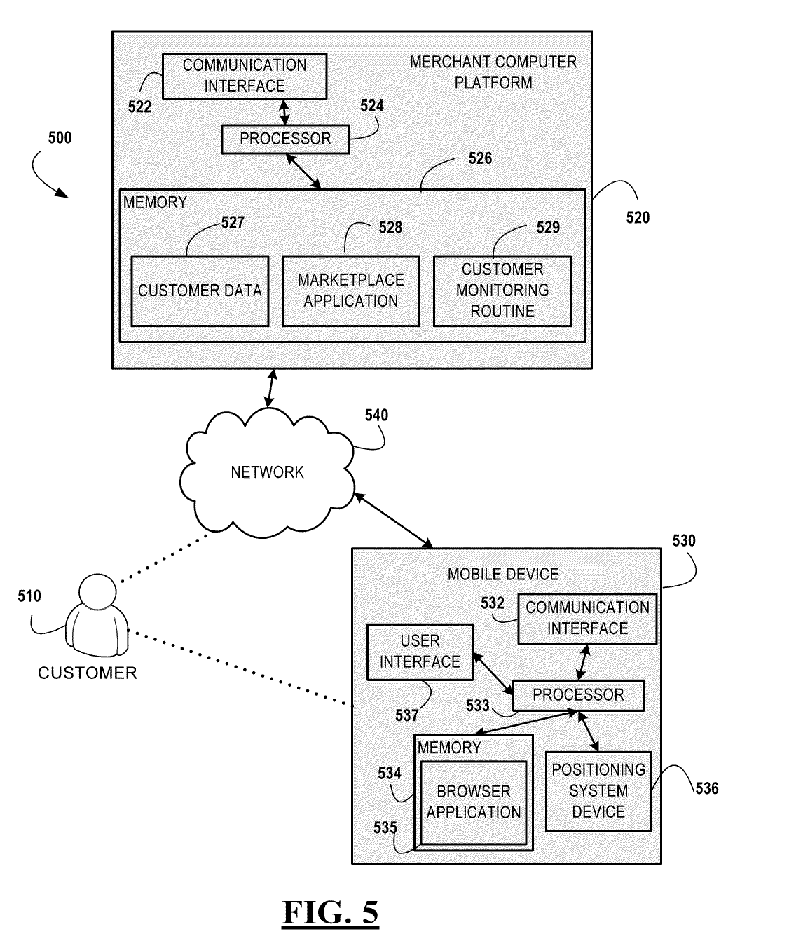

FIG. 5 provides a block diagram illustrating technical components for a system 500 for implementing a customer loyalty rewards program, in accordance with an embodiment of the present invention. As illustrated, the system 500 includes a customer 510, a merchant computer platform 520, a mobile device 530 and a network 540. It will be understood that the customer 550 has access to the mobile device 530.

As shown in FIG. 5, the merchant computer platform 520 and mobile device 530 are each operatively and selectively connected to the network 540, which may include one or more separate networks. In addition, the network 540 may include a local area network (LAN), a wide area network (WAN), and/or a global area network (GAN), such as the Internet. It will also be understood that the network 540 may be secure and/or unsecure and may also include wireless and/or wireline technology.

The mobile device 530 may include any computerized apparatus that can be configured to perform any one or more of the functions of the mobile device 530 described and/or contemplated herein. Such a mobile device may include, but is not limited to, a cellular telecommunications device (i.e., a cell phone or mobile phone), personal digital assistant (PDA), smartphone, a mobile Internet accessing device, or other mobile device including, but not limited to portable digital assistants (PDAs), pagers, gaming devices, laptop computers, tablet computers, and any combination of the aforementioned, or the like. As shown in FIG. 5, in accordance with some embodiments of the present invention, the mobile device 530 includes a communication interface 532, a processor 533, a memory 534 having a browser application 535 stored therein, a positioning system device 536, such as a GPS device, and a user interface 537. In such embodiments, the communication interface 532 is operatively and selectively connected to the processor 534, which is operatively and selectively connected to the user interface 537, the memory 534 and the positioning system device 536.

The user interface 538, which may allow the mobile device 530 to receive data from the customer 550, may include any of a number of devices allowing the mobile device 530 to receive data from the customer 550, such as a keypad, keyboard, touch-screen, touchpad, microphone, mouse, joystick, stylus, other pointer device, button, soft key, and/or other input device(s). In some embodiments, the user interface 538 also includes one or more user output devices, such as a display and/or speaker, for presenting information to the customer 550.

Each communication interface described herein, including the communication interface 532 and 522, generally includes hardware, and, in some instances, software, that enables a portion of the system 500, such as the processor 533 to transport, send, receive, and/or otherwise communicate information. For example, the communication interface 532 of the mobile device 530 may include a modem, server, electrical connection, and/or other electronic device that operatively connects the mobile device 530 to another electronic device, such as the electronic devices that make up the merchant computer platform 520.

Each processor described herein, including the processor 533 and 524, generally includes circuitry for implementing the audio, visual, and/or logic functions of that portion of the system 500. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as the memory 534 of the mobile device 530 and the memory 526 of the merchant computer platform 526.

Each memory device described herein, including the memory 536 for storing the browser application 535 and other data and/or programs, may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 5, the memory 534 of the mobile device 530 includes a browser application 535. The browser application 535 in some embodiments may be used by the customer 550 to access over the network 540 a secure website maintained by the merchant for viewing information about the customer's credited points, received rewards and to facilitate the exchange of rewards, to spin the rewards wheel etc. In some embodiments, the browser application 535 includes computer-executable program code portions for instructing the processor 534 to perform one or more of the functions of the browser application 535 described and/or contemplated herein. In some embodiments, the browser application may be configured to a collect and transmit through the communication interface data regarding the customer's activities to enable the merchant to determine when one or more activities have been completed (block 120, FIG. 1). In some embodiments, the browser application 535 may include and/or use one or more network and/or system communication protocols.

It will be understood that the mobile device 530 can be configured to implement one or more portions of the process flows described and/or contemplated herein. For example, in some embodiments, the user interface apparatus 530 is configured so that the communication interface 532 is operatively and selectively linked to the merchant computer platform 520 to facilitate the exchange of rewards (block 150 of FIG. 1). For instance, information regarding the points credited to the customer may be displayed on the display of the user interface 537, e.g. the display may show the customer's balance of points, the amount of points needed to receive an additional reward, a graphical representation of the progress towards specific rewards etc. As discussed, the customer 510 may be able to access a secure website via the browser application 535 and the communication interface 532 accessing the merchant computer platform over the network 540. In other embodiments (not shown) an application may be stored in the memory 534 of the mobile device 530 that enables the mobile device to perform some or all of the steps of process flow 100-300 shown in FIGS. 1-3. In further embodiments, the mobile device may determine the location of the customer 510 by information provided by the positioning system device 536 that the customer 510 is near location where she can redeem one or more of the rewards received as part of the customer loyalty rewards program. For example, the customer may have received a reward for twenty percent off any purchase from a local hair salon. The GPS device in the customer's mobile phone may determine that the customer is within two hundred feet of the hair salon and provide an alert, such as a visual display, vibration, audible warning etc. alerting the customer to the opportunity to redeem a reward.

FIG. 5 also illustrates a merchant computer platform 520, in accordance with an embodiment of the present invention. The merchant computer platform 520 may include any computerized apparatus that can be configured to perform any one or more of the functions of the merchant computer platform 520 described and/or contemplated herein. In accordance with some embodiments, for example, the merchant computer platform 520 may include an engine, a platform, a server, a database system, a front end system, a back end system, a personal computer system, and/or the like. In some embodiments, such as the one illustrated in FIG. 5, the merchant computer platform 520 includes a communication interface 522, a processor 524 and a memory 526. In some embodiments, as illustrated in FIG. 5, customer data (such as transactional data, account history data, social network data and Internet data) 527, a marketplace application 526 and a customer monitoring routine 529 may be stored in memory 526. The customer data 527 may have been previously collected and stored in the memory 526 of the merchant computer platform 520, or the merchant computer platform may actively collect customer data 527 by using the communication interface 522 to access the network 540 and only temporarily saves the customer data 527 to the memory to be accessed by the processor 524. The communication interface 522 is operatively and selectively connected to the processor 524, which is operatively and selectively connected to the memory 526.

It will be understood that the merchant computer platform 520 can be configured to implement one or more portions of the process flows described and/or contemplated herein. For example, in some embodiments, the merchant computer platform 520 is configured so that the processor assigns point values to a customer's completion of certain activities (block 110 of FIG. 1). In certain embodiments the customer monitoring routine 529, stored in memory 526 is configured to monitor the customer's activities, including the customer data 527, to determine when the customer has completed an activity (block 120, FIG. 1). In yet other embodiments, the marketplace application 528 stored in memory 526 is configured to credit the customer the assigned points for the completed activities, correlate the points to one or more rewards and facilitate the exchange of rewards as discussed and contemplated herein (blocks 130-150, FIG. 1).

It will be understood that the embodiment illustrated in FIG. 5 is exemplary and that other embodiments may vary. For example, in some embodiments, some or all of the portions of the system 500 may be combined into single portion. Specifically, in some embodiments, the merchant computer platform 520 is configured to perform all of the same functions of those separate portions as described and/or contemplated herein. Likewise, in some embodiments, some or all of the portions of the system 500 may be separated into two or more distinct portions.

As an example of this system in use, a customer 510 may receive an e-mail notification from a financial institution, e.g. from the merchant computer platform 520, indicating that he has received six hundred rewards points for completing a savings goal. The customer 510 accesses the marketplace application 528 of the financial institution over the network 540, e.g. the Internet, using his laptop 530. The customer 510 browses the available rewards on a “Get Rewards” portion of the marketplace application 528 to determine what rewards are available. The customer 510 elects to redeem three hundred of his points for two months of credit protection. The merchant computer platform 520 processes the exchange and enrolls the customer in the credit protection program. The customer 510 recognizes that he has a number of additional points remaining and elects to exchange one hundred points for a spin at the Rewards Wheel. The Rewards Wheel stops on a $10 gift certificate to an office supply merchant. The merchant computer platform 520 uses the communication interface 522 to send an electronic communication over the network 540 to the customer's 510 laptop 530. The electronic communication includes an attachment with the information necessary for the office supply merchant to process the reward.

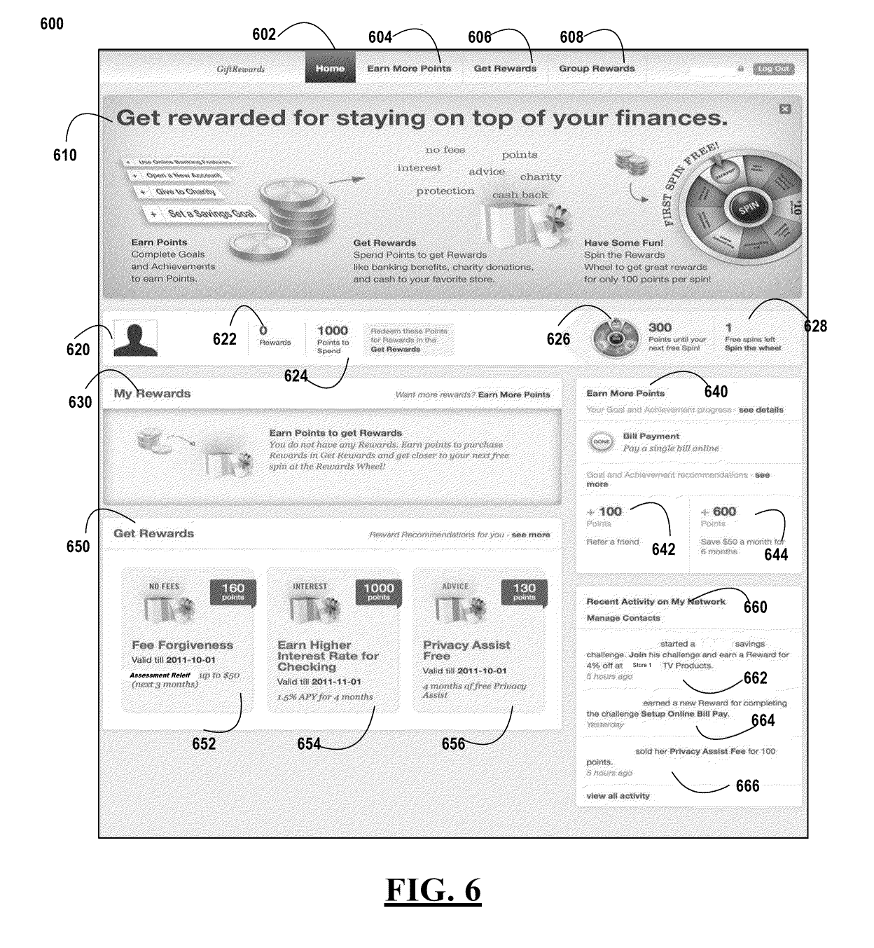

Referring now to FIGS. 6-10, a series of exemplary display pages 600-1000 illustrating customer interfaces for implementing a customer loyalty and rewards program consistent with embodiments of the present invention are provided. It will be understood, that in some embodiments, each of the pages 600, 700, 900 and 1000 is displayed on the same display that is operatively connected and/or otherwise associated with the user interface 538. Page 800 may also be displayed on a display that is operatively connected and/or otherwise associated with the user interface 538, but page 800 illustrates an embodiment of a display page for a mobile device. In one embodiment, pages 600-1000, and similar pages are displayed to a customer of a financial institution in the context of the financial institution's online or mobile banking environment.

It will also be understood that the display pages 600-1000 are, in one embodiment, configured to navigate from the 600 to the page 700, from the page 700 to the page 800 (or an equivalent display for a non-mobile device), from page 800 to page 900, from page 900 to page 1000 and vice versa. It will be further understood that the display pages 600-1000 can be embodied as portions of a dashboard application, portions of a portal application, as intranet pages, as Internet web pages, as the display associated with a mobile application, and/or the like. In addition, it will be understood that, in some embodiments, the systems, methods and apparatus having the process flow 100, 200, 300, 400 and/or 500 are configured to implement any one or more of the embodiments of the present invention described and/or contemplated herein in connection with the display pages 600-1000. For instance, the display pages 600-1000 may be displayed after, or in response to an apparatus or system facilitating the exchange of rewards (e.g. an apparatus having the flow 100, the merchant computer platform 520, etc.). The display page 600-1000 may also be displayed by an apparatus or system creating a social networking environment for communicating activities by which customers may earn rewards and facilitating the exchange of rewards between connections within the social network (e.g. an apparatus having the flow 300, the merchant computer platform 520, etc.). Alternatively, the display pages 600-1000 are displayed after the customer navigates to the page over the network 540 (e.g. the Internet, an Intranet, etc.) or from one of the other display pages, e.g. 700, 900, 1000, etc.

Referring now to FIG. 6 a display page 600 is provided illustrating an exemplary home page of an embodiment of the customer rewards and loyalty system disclosed and contemplated herein. As shown, in this embodiment, the display page 600 includes a menu bar including the fields Home 602, Earn More Points 604, Get Rewards 606 and Group Rewards 608, which can be used to navigate to various other display pages.

The embodiment of display 600 shown also includes an informational banner 610 for providing information and instructions about the customer rewards and loyalty program disclosed and contemplated herein. The informational banner can be used to provide an overview of the program that is presented to a customer when he or she first accesses a website associated with the system. In some such embodiments, the information banner will not appear on subsequent visits to the display page and/or the customer can elect to close the informational banner. In the embodiment shown, display page 600 also includes a profile bar 620. The profile bar 620 provides information regarding the customer's rewards account including an accounting of the total number of rewards received by the customer 622 and the points the customer has earned 624 and has available to exchange for additional rewards or spins of the Rewards Wheel. In certain embodiments, the profile bar 620 also includes a summary of the number of points the customer needs to earn to receive a free spin of the Rewards Wheel 626 and the total number of free spins currently available to the customer 628.

As shown in FIG. 6, the display page 600 also includes a My Rewards section 630 that provides information regarding the rewards received by the customer. As discussed herein, such rewards may have been received in exchange for points earned by completing activities, as gifts or in exchange for other rewards. If a customer has not yet received any rewards, the My Rewards section 630 may include information about how the customer may earn points to exchange for rewards or for spins of the Rewards Wheel.

In some embodiments, the display page 600 includes an Earn More Points section 640 that provides a list of activities, such as referring a friend 642, or completing a savings goal 644, that a customer may complete to earn more rewards. The Earn More Points section 640 may include graphical indicators providing information regarding whether the customer has started an activity, has completed and activity or the activity is in progress. As previously discussed, a customer may elect to share such information with the customer's connections within the social network disclosed herein. The Earn More Points section 640 of display page 600 may provide only a brief listing of available activities and may include a link allowing the customer to navigate to a complete listing of activities.

The display page 600 may also include a Get Rewards section 650 that provides information to the customer about available rewards, such as a Fee Forgiveness offer 652, a Higher Interest Rate offer 654 and a Privacy Assist offer 656. The Get Rewards section 650 may provide an overview of the nature of the reward, the number of points required to redeem the reward and any time limitations associated with reward. In some embodiments, certain portions of this information will be concealed from the customer until such time as the customer elects to redeem the reward, thereby creating an element of surprise and chance in connection with the exchange of points for rewards. The Get Rewards section 650 of display page 600 may provide only a brief listing of rewards available to the customer and may include a link allowing the customer to navigate to a complete listing of available rewards.

Certain embodiments of the invention as illustrated by display page 600 may include a My Network section 660 to display information about the activities of the customer's connections within the social network disclosed and contemplated herein. The information displayed in the My Network section 660 may include information regarding the activities a connection is participating in 662, the rewards a connection has recently received 664, and a connection's activities in the marketplace established to facilitate the exchange of rewards 666. The My Network section 660 of display page 600 may provide only a brief listing of the customer's connections activity and may include a link allowing the customer to navigate to a complete listing of the customer's connections' activities.

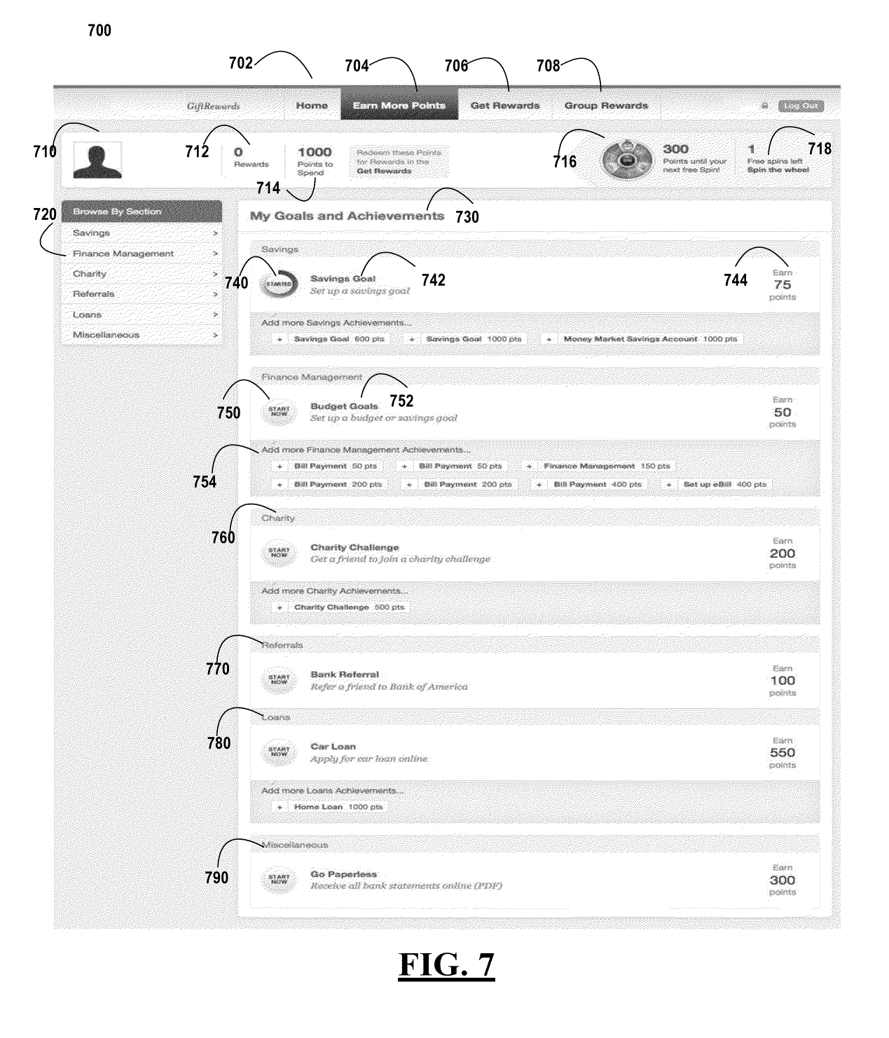

Referring now to FIG. 7, a display page 700 is provided illustrating a customer interface for providing information to the customer about available activities or activities in which the customer is already participating in order to earn more points. As shown, display page 700 includes a menu bar including the fields Home 702, Earn More Points 704, Get Rewards 706 and Group Rewards 708, which can be used to navigate to various other display pages. Display page 700 as shown also includes a profile bar 710 that provides information regarding the customer's rewards account including an accounting of the total number of rewards received by the customer 712 and the points the customer has earned 714 and has available to exchange for additional rewards or spins of the Rewards Wheel. In certain embodiments, the profile bar 710 also includes a summary of the number of points the customer needs to earn to receive a free spin of the Rewards Wheel 716 and the total number of free spins currently available to the customer 718.

As shown, display page 700 includes a Browse by Section box 720 that enables a customer to review available activities according to the nature of the activity. For instance, a customer may be interested in completing an activity associated with Charity, and consequently, may select the potion of the Browse by Section box 720 labeled Charity. In the embodiment shown, display page 700 also includes a My Goals and Achievements section 730 for providing information to the customer about activities the customer can participate in, the activities the customer is currently participating in and/or those activities the customer has already completed. In some embodiments, the activities will be identified by a title (e.g. 742, 752) and include a brief summary of the nature of the activity. The display page will also include information about the number of points that the customer will receive for completing an activity, e.g. 744. Activities may also be presented by category, see for example 760-790, so that all activities associated with a given category are grouped together.

In some embodiments, when a customer chooses to participate in an activity the activity will be prominently displayed on display page 700. Additional available activities may also be presented and the customer can elect to add one or more activities, e.g. 754 to those in which the customer intends to participate. The customer can choose to start an activity when he or she is ready to participate by actuating a Start Now button 750 or a button with similar functionality. Once an activity is started, display page 700 includes a graphical indicator 740 indicating that the activity has been started. In some embodiments, the graphical indicator 740 will also provide an indication as to how close the customer is to completing the activity. For instance, the meter surrounding the graphical indicator 740 shown in FIG. 3 may fill until the circle with the word “started” is surrounded indicating the activity has been completed.

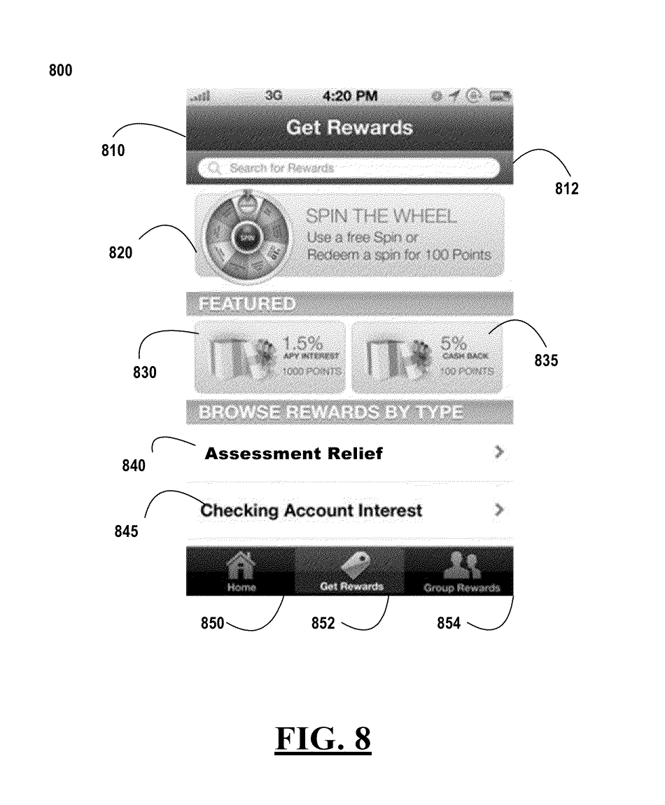

Referring now to FIG. 8, a display page 800 is provided illustrating an exemplary display page for providing information to a customer to facilitate the exchange of rewards. The particular embodiment of the display page 800 shown relates to a display page to be presented on a mobile device, such as a mobile telephone, smartphone, personal digital assistant etc. However, it will be understood that in certain embodiments the information contained in display page 800 will be presented on a display page suited for a non-mobile device, such as a computer dashboard, webpage etc. It will also be understood that the information contained in the display pages 600, 700, 900 and 1000 may be presented in a display page, similar to display page 800, particularly suited to be presented on a mobile device.

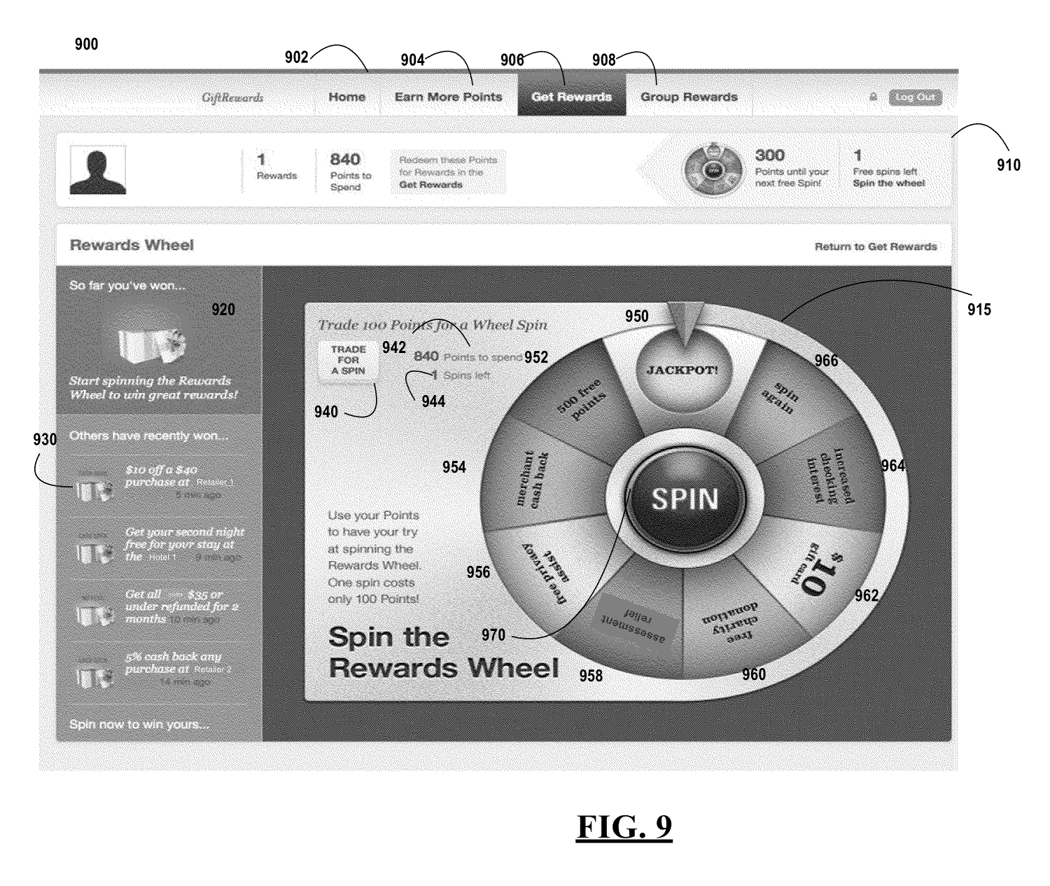

As shown, display page 800 includes a title banner 810 identifying the display page as being associated with the get rewards functionality of the apparatus and systems disclosed and contemplated herein. Also included are a Home button 850, Get Rewards button 852 and Group Rewards button 854, which can be used to navigate to various other display pages. A Search field 812 is also provided enabling the customer to manually input search terms associated with a desired reward to determine if any corresponding rewards are available. At 820, a customer is presented with the option of spinning the Rewards Wheel to receive a reward. In some embodiments, the customer will be able to spin the rewards wheel directly from the display presented at 820. In other embodiments, selecting the area of the display associated with the Rewards Wheel 820 navigates the customer to a display page, such as display page 900 of FIG. 9 associated with the Rewards Wheel. Display page 800 also includes, in the embodiment shown, a section displaying Featured Rewards 830 and 835. The customer may select the section of the display page associated with these featured rewards and be presented with additional information about the rewards and/or the option to redeem points in exchange for the rewards. As shown, the display page 800 may also include a section enabling the customer to browse rewards by type, for example rewards associated with Fee Forgiveness 840 or Checking Account Interest 845, etc. The customer may select the section of the display associated with a rewards type and be presented with a listing of available rewards. The customer may be presented with additional rewards types by scrolling down to identify other categories.

Referring now to FIG. 9, a display page 900 is provided illustrating an exemplary display page associated with facilitating the exchange of rewards through the use of a Rewards Wheel consistent with embodiments of the present invention. As shown, display page 900 includes a menu bar including the fields Home 902, Earn More Points 904, Get Rewards 906 and Group Rewards 908, which can be used to navigate to various other display pages. Display page 900 also includes a profile bar 910 that provides information regarding the customer's rewards account. Display page 900 also prominently includes a Rewards Wheel 915. The Rewards Wheel 915 is divided into different sections 950-966 corresponding to different rewards, such as free points 952, merchant cash back 954, free privacy assist 956 etc. In the center of the Rewards Wheel 915 is a Spin button 970 that the customer may actuate to initiate the spinning of the Rewards Wheel 915. Display page 900 also includes information regarding the total number of points available to the customer 942 and the number of spins the customer has accumulated 944. Also included, is a button 940 enabling the customer to exchange earned points for an opportunity to spin the Rewards Wheel 915. In the embodiment shown, one hundred points may be exchanged for one spin of the Rewards Wheel 915. It will be understood that the amount of points required in exchange for a spin illustrated in FIG. 9 is exemplary and the number of points required may vary. Further, display page 900 includes a rewards section 920 providing information regarding any rewards awarded to the customer from spinning the Rewards Wheel 915. If the customer has not yet spun the Rewards Wheel 915, and therefore has not yet received a reward, the rewards section 920 may provide information about how to receive rewards by spinning the Rewards Wheel 915. Display page 900 also includes information regarding the rewards won by others, e.g. 930, from spinning the Rewards Wheel 915. In some embodiments, the others discussed in this section will be the customer's connections within the social network disclosed and contemplated herein. In other embodiments, the others are other customers of the merchant (e.g. a financial institution, retailer, etc.).

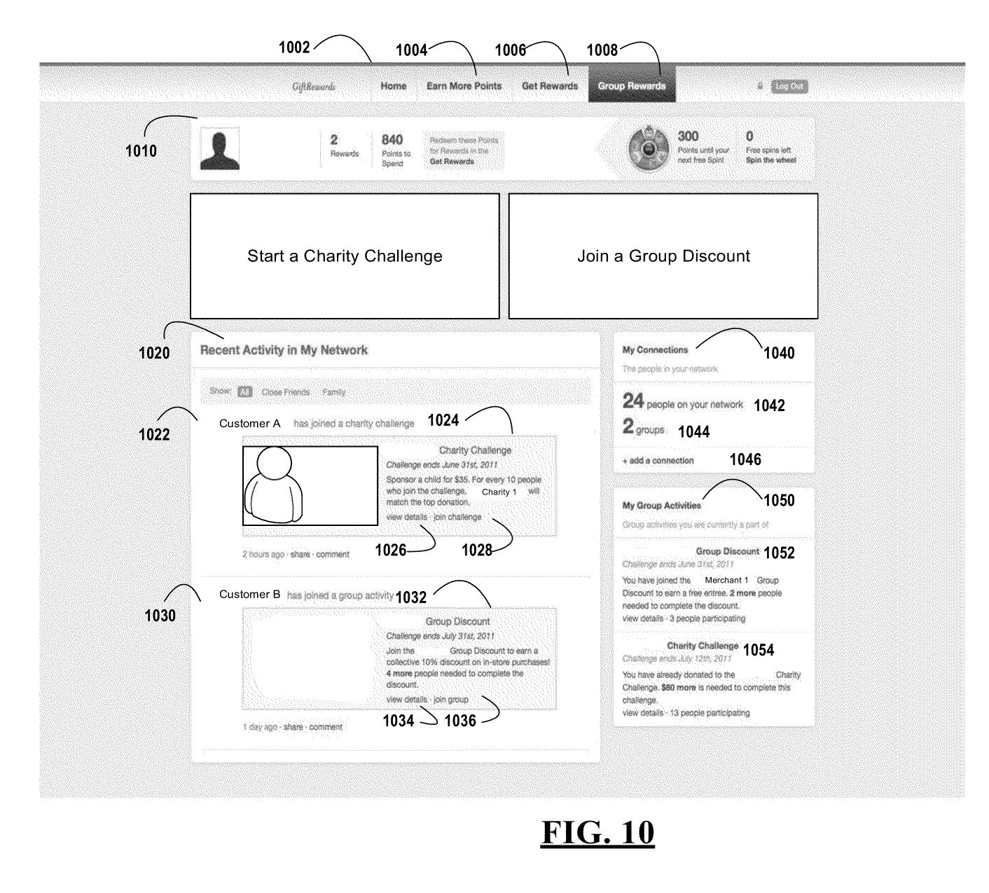

Referring now to FIG. 10, a display page 1000 is provided illustrating a social network environment for communicating activities by which customers may earn points and facilitating the exchange of rewards, consistent with an embodiment of the present invention. As shown, display page 1000 includes a menu bar including the fields Home 1002, Earn More Points 1004, Get Rewards 1006 and Group Rewards 1008, which can be used to navigate to various other display pages. Display page 1000 also includes a profile bar 1010 that provides information regarding the customer's rewards account. As shown, display page 1000 includes a My Network section 1020 that provides information about the charity challenges and group challenges in which the customer's connections are participating. In certain embodiments, the displayed information can be limited to those connections that have been identified as close friends or family members. In other embodiments, the displayed information will relate to all of the customer's connections. As illustrated by FIG. 10, display page 1000 indicates that Customer A 1022 has joined a charity challenge. The name of the charity challenge and the particulars of the challenge are displayed 1024 and the customer is given the opportunity view additional details about the challenge 1026 and/or join the challenge 1028. As shown, display 1000 indicates that Customer B 1030 has joined a group activity. The name of the group activity and the particulars of the activity are display 1032 and the customer is given the opportunity to view additional details about the activity 1034 and/or join the activity 1036. Display page 1000 also includes a My Connections section 1040 that provides information about the customer's connections within the social network, such as the number of people the customer is connected to 1042 and the number of groups in which the customer is a member 1044. The My Connections section 1040 may also include the functionality of enabling the customer to modify his or her connections, such as by adding 1046 or removing connections. In some embodiments, this may be done directly from display page 1000. In other embodiments, the customer will select a link, e.g. 1046, to navigate to a different display page (not shown) to modify his or her connections. Display page 1000 also includes a My Group Activities section 1050, which identifies the groups with which the customer is currently affiliated with. As shown, the My Group Activities section 1050, may include separate entries for each group, e.g. 1052, 1054, describing the nature of the group, the current participants and any additional actions or requirements needed to receive a reward or complete a charity challenge.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A method for implementing a customer loyalty rewards program, comprising:
assigning point values, via a processor, to a customer's completion of one or more activities;
monitoring, via the processor, the customer's activities to determine when the customer has completed an activity;
crediting the customer the assigned value of points for completed activities;
correlating points to one or more rewards; and
facilitating the exchange of the one or more rewards.

2. The method of claim 1, wherein the one or more activities are selected from: participating in a program, maintaining a specified balance in an account, meeting specific goals, contributing money to a charity, completing a transaction with a specified financial instrument, remaining a customer for a specified period of time, or referring other customers.

3. The method of claim 1, wherein the one or more rewards comprises discounts for goods or services the amount and nature of which is concealed from the customer until the customer elects to learn the details of the discount.

4. The method of claim 1, wherein the rewards comprise discounts for goods or services in a specific category the amount and nature of which is concealed from the customer until the customer elects to learn the details of the discount.

5. The method of claim 1, wherein the rewards are only valid for a limited period of time.

6. The method of claim 1, wherein facilitating the exchange of rewards comprises transferring one or more rewards to the customer in exchange for credited points.

7. The method of claim 1, wherein facilitating the exchange of rewards comprises: creating a marketplace, wherein the rewards may be purchased, sold, traded or gifted by and between customers.

8. The method of claim 1, further comprising:
identifying a plurality of customer groupings, wherein each grouping corresponds to a value to the merchant;
determining, via a processor, to which customer grouping the customer belongs.

9. The method of claim 8, wherein correlating points to one or more rewards is based in part on the customer grouping to which the customer belongs.

10. The method of claim 1, further comprising:
creating a social network environment, wherein customers can elect to associate with one or more other customers of the merchant.

11. The method of claim 10, further comprising, communicating additional activities through which a customer may earn points through the customer's connections in the social network.

12. The method of claim 10, wherein facilitating the exchange of rewards comprises enabling the exchange of rewards between customers connected through the social network.

13. The method of claim 1, wherein the one or more rewards comprise an opportunity to participate in a game of chance to receive additional rewards and facilitating the exchange of rewards, comprises presenting a game of chance wherein a participant receives one of a number of rewards of varying values according to predetermined rules.

14. The method of claim 13, wherein the game of chance is a rewards wheel.

15. The method of claim 14, wherein the rewards wheel is an electronic rewards wheel.

16. The method of claim 1, wherein facilitating the exchange of rewards comprises:
identifying the customer's location via a mobile device;
correlating the customer's location to available rewards within a predetermined distance from the customer's location; and
notifying the customer of the available rewards proximate to the customer's location.

17. An apparatus, comprising:
a memory comprising assigned point values associated with a customer's completion of one or more activities;
a processor, operably connected to the memory and configured to:
monitor the customer's activities to determine when the customer has completed an activity;
credit the customer the assigned value of points for completed activities;
correlate points to one or more rewards; and
facilitate the exchange of the one or more rewards; and
provide information for presentation to the customer about the credited points and the one or more rewards.

18. The apparatus claim 17, wherein the one or more activities are selected from: participating in a program, maintaining a specified balance in an account, meeting specific goals, contributing money to a charity, completing a transaction with a specified financial instrument, remaining a customer for a specified period of time, or referring other customers.

19. The apparatus of claim 17, wherein the one or more rewards comprise discounts for goods or services the amount and nature of which is concealed from the customer until the customer elects to learn the details of the discount.

20. The apparatus of claim 17, wherein the rewards comprise discounts for goods or services in a specific category the amount and nature of which is concealed from the customer until the customer elects to learn the details of the discount.

21. The apparatus of claim 17, wherein the rewards are only valid for a limited period of time.

22. The apparatus of claim 17, wherein the processor in facilitating the exchange of rewards is configured to transfer one or more rewards to the customer in exchange for credited points.

23. The apparatus of claim 17, wherein the processor in facilitating the exchange of rewards is configured to: create a marketplace, wherein the rewards may be purchased, sold, traded or gifted by and between customers

24. The apparatus of claim 17, wherein the processor is further configured to:
identify a plurality of customer groupings, wherein each grouping corresponds to a value to the merchant; and
determine to which customer grouping the customer belongs.

25. The apparatus of claim 17, wherein correlating points to one or more rewards is based in part on the customer grouping to which the customer belongs.

26. The apparatus of claim 17, wherein the processor is further configured to:
create a social network environment, wherein customers can elect to associate with one or more other customers of the merchant.

27. The apparatus of claim 26, wherein the processor is further configured to communicate additional activities through which a customer may earn points through the customer's connections in the social network.

28. The apparatus of claim 26, wherein the processor in facilitating the exchange of rewards is configured to enable the exchange of rewards between customers connected through the social network.

29. The apparatus of claim 17, wherein the one or more rewards comprises an opportunity to participate in a game of chance to receive additional rewards and facilitating the exchange of rewards, comprises presenting a game of chance, via the display, wherein participants receive one of a number of rewards of varying values according to predetermined rules.

30. The apparatus of claim 29, wherein the game of chance is a rewards wheel.

31. The apparatus of claim 29, wherein the rewards wheel is an electronic rewards wheel.

32. The apparatus of claim 17, wherein the processor in facilitating the exchange of rewards is configured to:
identify the customer's location via a mobile device;
correlate the customer's location to available rewards within a predetermined distance from the customer's location; and
notify the customer of the available rewards proximate to the customer's location.

33. A computer-program product, comprising:
a non-transitory computer-readable medium having computer-executable code stored thereon, the computer-executable code comprising:
a first code portion configured to monitor a customer's activities;
a second code portion configured to award a predetermined number of points to the customer for the completion of designated activities; and
a third code portion configured to exchange the customer's points for one or more rewards.

34. The computer-program product of claim 33, wherein the designated activities are selected from: participating in a program, maintaining a specified balance in an account, meeting specific goals, contributing money to a charity, completing a transaction with a specified financial instrument, remaining a customer for a specified period of time, or referring other customers.

35. The computer-program product of claim 33, wherein the one or more rewards comprise discounts for goods or services the amount and nature of which is concealed from the customer until the customer elects to learn the details of the discount.

36. The computer-program product of claim 33, wherein the rewards comprise discounts for goods or services in a specific category the amount and nature of which is concealed from the customer until the customer elects to learn the details of the discount.

37. The computer-program product of claim 33, wherein the rewards are only valid for a limited period of time.

38. The computer-program product of claim 33, wherein the third code portion in exchanging the customer's points for one or more rewards is configured to transfer one or more rewards to the customer in exchange for credited points.

39. The computer-program product of claim 33, wherein the third code portion in exchanging the customer's points for one or more rewards is configured to: create a marketplace, wherein the rewards may be purchased, sold, traded or gifted by and between customers

40. The computer-program product of claim 33, further comprising a code portion configured to:
identify a plurality of customer groupings, wherein each grouping corresponds to a value to the merchant; and
determine to which customer grouping the customer belongs.

41. The computer-program product of claim 40, wherein the predetermined point value awarded to a customer for the completion of designated activities is based in part on the customer grouping to which the customer belongs.

42. The computer-program product of claim 33, further comprising a code portion configured to:
create a social network environment, wherein customers can elect to associate with one or more other customers of the merchant.

43. The computer-program product of claim 42, further comprising a code portion configured to communicate additional activities through which a customer may earn points through the customer's connections in the social network.

44. The computer-program product of claim 42, wherein the third code portion in exchanging the customer's points for one or more rewards is configured to enable the exchange of rewards between customers connected through the social network.

45. The computer-program product of claim 33, wherein the one or more rewards comprises an opportunity to participate in a game of chance to receive additional rewards and further comprising a fourth code portion configured to present a game of chance, wherein participants receive one of a number of rewards of varying values according to predetermined rules.

46. The computer-program product of claim 45, wherein the game of chance is a rewards wheel.

47. The computer-program product of claim 45, wherein the rewards wheel is an electronic rewards wheel.

48. The computer-program product of claim 33, wherein the third code portion in exchanging the customer's points for one or more rewards is configured to:
identify the customer's location via a mobile device;
correlate the customer's location to available rewards within a predetermined distance; and
notify the customer of the available rewards proximate to the customer's location.

49. A method for attracting customers to a financial institution platform, comprising:
providing electronic games on a financial institution platform; and
enabling customers to access the electronic games.

50. The method of claim 49, wherein the electronic games provide customers with rewards for participating in the game.
